(19) United States
(12) Patent Application Publication
(10) Pub. No.: US 2018/0080859 A1
(43) Pub. Date: Mar. 22, 2018

(54) Apparatus and Method For Validating Water Level in Condensate Measurement

(71) Applicant: Phase Dynamics, Inc., Richardson, TX (US)

(72) Inventor: Bentley N. SCOTT, Garland, TX (US)

(21) Appl. No.: 15/710,551

(22) Filed: Sep. 20, 2017

Related U.S. Application Data
(60) Provisional application No. 62/397,057, filed on Sep. 20, 2016.

(51) Int. Cl. G01N 5/02

(52) U.S. Cl. CPC G01N 5/025

(57) ABSTRACT

An apparatus for determining the amount of water in a liquid condensate. The apparatus comprises a vessel for containing a stream of liquid condensate. A first section of the vessel comprises an inlet for receiving the stream of liquid condensate and a second section of the vessel comprises an outlet for outputting the stream of liquid condensate. The inlet is configured to be removably coupled to an input feed line and the outlet is configured to be removably coupled to an output feed line. The apparatus further comprises an adsorbent material disposed in the vessel for removing water from the liquid condensate and a cap configured to be removably coupled to an opening in the vessel to thereby allow the adsorbent to be removed from the vessel.

### CROSS-REFERENCE TO RELATED APPLICATION(S) AND CLAIM OF PRIORITY

The present application is related to U.S. Provisional Patent No. 62/397,057, filed Sep. 20, 2016, entitled “Method For Validation Of PPM Level Water in Condensate Measurement”. Provisional Patent No. 62/397,057 is assigned to the assignee of the present application and is hereby incorporated by reference into the present application as if fully set forth herein. The present application hereby claims priority under 35 U.S.C. §119(e) to U.S. Provisional Patent No. 62/397,057.

### TECHNICAL FIELD

The present application relates generally to apparatuses and methods for validating an analyzer for the amount of water at parts-per-million (PPM) levels in a condensate.

### BACKGROUND

The measurement of water levels in the parts-per-million (PPM) range in gas condensate is important due to the formation of hydrates, which can block a pipeline and potentially create a rupture if the levels are not kept below 250 PPM. When crude oil containing water is pumped from underground to the surface of the earth, water is removed from the liquid gas condensate during refinement through process having 3-5 steps. The steps may include bulk water removal, cooling, and coalescing. The accurate determination of water content in a liquid gas condensate may help in preventing potentially hazardous hydrate formation in the pipelines. This is especially important in cold climates, such as Canada and for offshore platforms where the pipeline sends the liquids to shore through a subsea pipeline. If a rupture occurs due to hydrate formation, the expense and damage may be great.

Refining processes typically use real-time, online water measurement analyzers to determine the PPM level of water in liquid condensates. One exemplary real-time, online water measurement analyzer is disclosed in U.S. Pat. No. 6,630,833, which is hereby incorporated by^{,} reference as if fully set forth herein. However, the accuracy of the real-time analyzers must be periodically verified by an offline sample testing apparatus that separately tests the water content of a sample of liquid condensate to confirm the measurements made by the real-time, online water measurement analyzer. Such an offline method involves physically sampling the stream and analyzing it in a laboratory setting.

However, one problem with the offline method is that the liquid gas condensate evaporates due to the high vapor pressure of the liquid, therefore biasing the sample. In addition, since the amount of water is at PPM levels, only a titration laboratory determination of water can be processed. Titration in the laboratory is highly dependent upon the operator and sample handling The object of titration is to collect a sample which is representative of the entire process stream while pulling a sample size of less than 1 milliliter. Typically, the sample is captured in a small section of line with valves on both sides and easy to disconnect fittings in between. When the sample is blocked in and then the fittings are separated, the water may condense from the atmosphere due to the cooling effect caused by “flashing” of the condensate left in the fitting. During flashing, the container is cooled due to the expansion of the liquids into gas and ambient air water vapor can easily be condensed on the surfaces. This small amount of condensed water may enter the titration apparatus, thereby biasing the measurement. Other techniques to determine PPM levels of water are also affected by flashing and liquid condensate-to-gas transitions before making an accurate measurement.

Therefore, there is a need in the art proved methods and apparatuses of accurately determining the amount of water in a sample of a liquid condensate extracted from a petroleum processing pipeline. In particular, there is a need for improved methods and apparatuses of accurately determining the amount of water in the parts-per-million (PPM) range in a liquid condensate that are not affected by the extraction process or by changes in temperature and pressure during the testing process.

### SUMMARY

To address the above-discussed deficiencies of the prior art, it is a primary object o provide an apparatus for determining the amount of water in a liquid condensate. The apparatus comprises a vessel for containing a stream of liquid condensate. A first section of the vessel. comprises an inlet for receiving the stream of liquid condensate and a second section of the vessel comprises an outlet for outputting the stream of liquid condensate. The inlet is configured to be removably coupled to an input feed line and the outlet is configured to be removably coupled to an output feed line. The apparatus further comprises an adsorbent material disposed in the vessel for removing water the liquid condensate and a cap configured to be removably coupled to an opening in the vessel to thereby allow the adsorbent to be removed from the vessel.

It is another object to provide a system for determining the amount of water in a liquid condensate. The system comprises: i) a flow meter configured to receive a stream of the liquid condensate from a process pipeline and further configured to determine a mass of the liquid condensate passing through the flow meter during a predetermined time period, T; and ii) a vessel coupled to the flow meter and configured to receive the stream of the liquid condensate from the flow meter. A first section of the vessel comprises an inlet configured to receive the stream of the liquid condensate and a second section of the vessel comprises an outlet configured to output the stream of the liquid condensate, wherein the outlet is configured to be removably coupled to an output feed line. The system further comprises: iii) an adsorbent material disposed in the vessel for removing water from the liquid condensate; and iv) a cap configured to be removably coupled to an opening in the vessel to thereby allow the adsorbent to be removed from the vessel.

It is still another object to provide a method for determining the amount of water in a liquid condensate. The method comprises: i) in a flowmeter, ice the liquid condensate from a process pipeline and determining a mass of the liquid condensate passing through the flow meter during a sample test period, T; ii) determining the total mass of the stream of the liquid condensate passing through the flow meter during the sample test period, T; iii) in a vessel containing an adsorbent material having a known initial mass, receiving the stream of the liquid condensate from the flow meter and removing water from the liquid condensate during the sample test period, T; iv) determining the final mass of the adsorbent material at the end of the sample test period T; v) comparing the known initial mass of the adsorbent material and the final mass of the adsorbent material to determine a mass of adsorbed water; and vi) using the mass of adsorbed water and the total mass of the stream of the liquid condensate to determine the concentration of water in the liquid condensate.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a system for processing multiphase fluid received from gas wells according to one embodiment of the disclosure.

FIG. 2 illustrates a valve arrangement for extracting samples of liquid condensate.

FIG. 3 illustrates an apparatus for validating water measurements in the parts-per-million (PPM) range in a dry liquid condensate according to one embodiment of the disclosure.

FIG. 4 illustrates a molecular sieve for validating water measurements in the PPM range in a dry liquid condensate according to one embodiment of the disclosure.

FIG. 5 illustrates a method for validating water measurements in the parts-per-million (PPM) range in a dry liquid condensate according to one embodiment of the disclosure.

### DETAILED DESCRIPTION

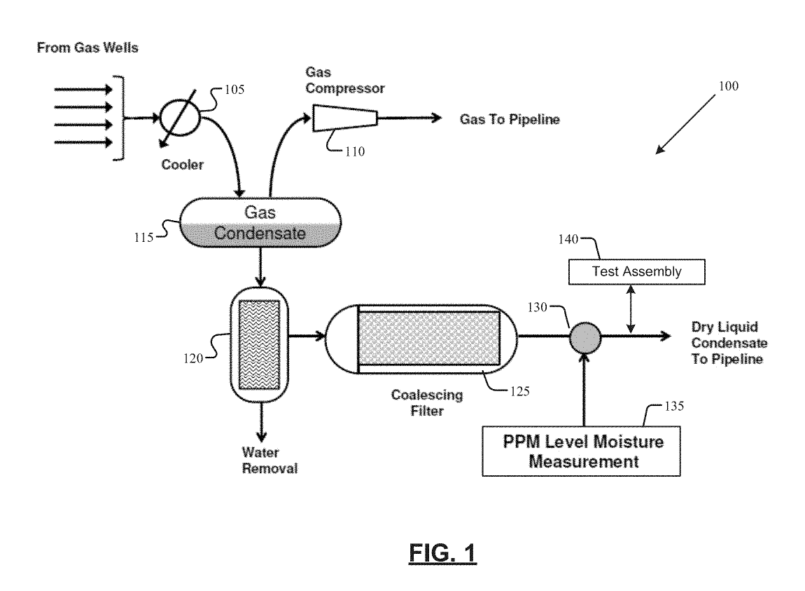

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged multiphase fluid processing system.

The present disclosure describes methods for validating a moisture analyzer for the amount of water at parts-per-million (PPM) levels in a condensate. The disclosed apparatus may be used to verify the operation of a real-time, online water measurement analyzer, such as the one described in U.S. Pat. No. 6,630,833. The disclosure of U.S. Pat. No. 6,630,833 is hereby incorporated into the present disclosure as if fully set forth herein. The disclosed apparatus verifies the accuracy of the real-time, online water measurement analyzer, thereby eliminating uncertainty of measurement.

The disclosed method and apparatus make use of a molecular sieve to capture water in larger quantities and without the problems associated with flashing. Molecular sieves are adsorbents composed of aluminosilicate crystalline or zeolites which are used in many industries for drying and removing contaminants. It is well known that these materials are capable of drying natural gas and liquids by adsorbing water. Molecular sieves are selective because of the pore sizes—with a 4 angstrom type (Type 4A) ha the ability to adsorb up to 20% by weight of water. Type 4A may be ordered with a saturation color change chemical embedded.

The disclosed apparatus includes an in-line system comprising a known weight of molecular sieve. Since the mass and volume flow rate of the condensate fluid may be determined precisely, a tune may be calculated with the estimated PPM level of water which will allow the molecular sieve to take in approximately 10% of its 20% maximum capacity. For example, a 1 kilogram (kg) volume of molecular sieve may be placed into a pipe section that has a 2 inch cross-sectional area and a 2 foot length, with fittings to allow the liquid condensate to flow through the molecular sieve at the same temperature and pressure as the process in the pipeline. The amount of molecular sieve needed to fill the system (i.e., 1 kg) is weighed before the system is sealed and installed in-line. Since only a portion of its total capacity is used, the molecular sieve does not need to be dehydrated at 550 degrees Celsius before being placed into the system.

In the exemplary embodiment, the amount of molecular sieve to fill this in-process system weighs approximately 1000 grams and at 10% by weight would require 100 grams of water to accumulate to reach 50% of the molecular sieve maximum saturated condition (i.e., half of the 20% maximum capacity). Thus, 100 grams of water with the process flowing at a rate of 6 liters/minute and a process PPM level of 200 PPM may be the operating conditions. One liter of water equals 1,000 grams by weight (at standard temperature). At 200 ppm (200×10⁻⁶), the flow rate of 6 liters/minute equals 1,200×10⁻⁶ (or 1.2×10⁻³) liters/minute of water. Converting to grams/minute results in (1,000 g/l)×(1.2×10⁻³ l/minute)=1.2 g/minute at 200 PPM level. Therefore, to obtain 100 grams of additional water in the molecular sieve, it would take 100 g/1.2 g/minute=83.34 minutes to arrive at this quantity of water in the molecular sieve. At testing time, the system would be isolated by valves and the process connections would be sealed. The molecular sieve is then removed from the system in a vent hood for safety and weighed. Any condensate would evaporate before the molecular sieve is weighed, but the water will not be removed unless the molecular sieve material is heated to 500 degrees Celsius.

Since the original weight of the molecular sieve material is known (i.e., 1 kg), the total flow of liquid condensate is known, and the resulting weight is the water accumulated over the 83.34 minutes, then the PPM level of water in the liquid condensate may be determined with less uncertainty than any prior art method.

FIG. 1 illustrates system 100 for processing multiphase fluid received from gas wells according to one embodiment of the disclosure. System 100 comprises cooler 105, gas compressor 110, gas and condensate tank 115, tank 120, coalescing filter tank 125, valve 130, real-time, online PPM level water analyzer 135, and test assembly 140. At the input to system 100, multiphase fluid comprising a mixture of oil, gas, and water is received from one or more gas/oil wells. The input liquid flow is chilled by cooler 510 and the liquid condensate is sent to gas and condensate tank 120. The gas and the condensate separate in tank 120 and the gas is extracted by gas compressor 110, which compresses the gas and sends the compressed gas to a pipeline.

The separated condensate is sent to tank 120 where most of the water is extracted from the liquid condensate and removed from tank 120. The output of tank 120 that is sent to coalescing filter tank 125 may be approximately 1% water. Coalescing filter tank 125 then further separates water from the hydrocarbon liquid condensate. The output of coalescing filter tank 125 will be a dry liquid condensate that may typically have water content of less than 350 PPM. During real-time operations, valve 130 may be used to extract samples of the liquid condensate which are then analyzed by PPM level moisture measurement analyzer 135. PPM level moisture measurement analyzer 135 performs real-time online measurements to determine a precise amount of water in the PPM range) in the dry liquid condensate. For example, PPM level moisture measurement analyzer 135 may determine that the dry liquid condensate contains a water level of 125 PPM.

It is necessary from time-to-time to verify the operation of PPM level moisture measurement analyzer 135 with a high degree of accuracy. To accomplish, this test assembly 140 may be used to extract an additional sample of the dry liquid condensate so that highly accurate offline sample testing may be performed to verify that PPM level moisture measurement analyzes 135 is operating accurately.

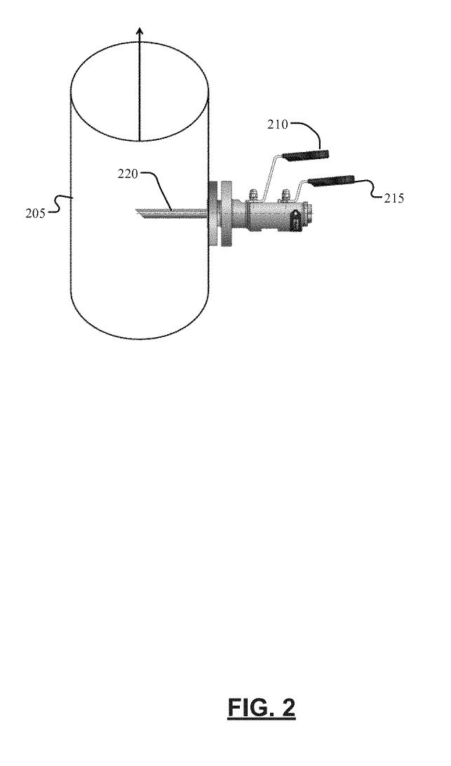

FIG. 2 illustrates a valve arrangement for extracting samples of dry liquid condensate from process pipeline 205. Process pipeline 205 may be the same pipeline from which sample are extracted and sent to PPM level moisture measurement analyzer 135 for real-time, online testing. In an exemplary embodiment, pipeline 205 may be a 2 inch pipe. Sample quill 220 is inserted through the wall of pipeline 205 so that the dry liquid condensate may be extracted and sent to test assembly 140. Valves 210 and 215 control the flow of the dry liquid condensate from pipeline 205 through sample quill 220 to test assembly 140.

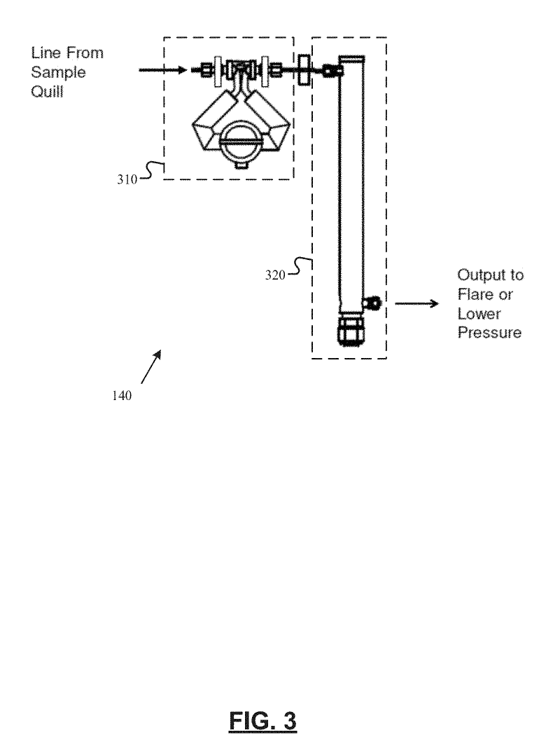

FIG. 3 illustrates test assembly 140 for validating water measurements in the parts-per-million (PPM) range in a dry liquid condensate according to one embodiment of the disclosure. Test assembly 140 comprises flow meter 310 and molecular sieve assembly 320. Flow meter 310 receives the liquid condensate sample from sample quill 220 when valves 210 and 215 are opened and outputs the liquid condensate to molecular sieve assembly 320. Flow meter 310 accurately determines the volume (and mass) of the liquid condensate sample that flows into molecular sieve assembly 320 during a test period having a predetermined duration of “T” seconds. In FIG. 3, flow meter 310 is depicted as a Coriolis flow meter. However, this is by way of illustration only. In general, flow meter 310 may be any one of a number of types of precision flow

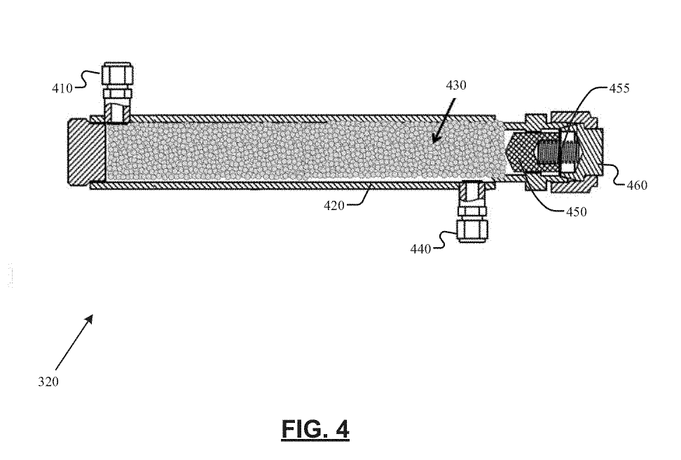

FIG. 4 illustrates molecular sieve assembly 320 for validating water measurements in the PPM range in a dry liquid condensate according to one embodiment of the disclosure. Molecular sieve assembly 320 comprises vessel 420 for containing a stream of liquid condensate. In FIG. 420, vessel 420 comprises a cylindrical section of pipe. However, this is by way of illustration only and should not be construed to limit the scope of the disclosure. In alternate embodiments, vessel 420 may comprise other shapes including, for example, a spherical tank.

A first section of vessel 420 comprises inlet 410 for receiving the stream of liquid condensate and a second section of vessel 420 comprises outlet 440 for outputting the stream of liquid condensate. Inlet 410 is configured to be removably coupled to an input feed line from flow meter 310 and outlet 440 is configured to be removably coupled to an output feed line that may go to a flare that burns off the condensate or another lower pressure environment. By way of example and not limitation, inlet 410 and outlet 440 may be threaded pipe segments that may be screwed onto the input and output feedlines.

Molecular sieve assembly 320 further comprises adsorbent material 430 disposed in vessel 420 for removing water from the liquid condensate. By way of example and not limitation, adsorbent material 430 may comprise a plurality of molecular sieve beads, such as aluminosilicate crystalline beads or zeolite beads. The molecular sieve beads have selective pore sizes (e.g., 4 angstrom type) that are capable of adsorbing up to 20% by weight of water. Type 4A adsorbent material 430 may comprise an embedded saturation color change chemical.

Molecular sieve assembly 320 further comprises cap 460, spring 455, and plug 450. Cap 460 is configured to be removably coupled to an opening at one end of vessel 420. When tightened, cap 460 presses against spring 455, which then presses plug 450 against adsorbent material 430 to keep it firmly packed. The opening allows adsorbent material 430 to be removed from vessel 420 and weighed after the test sample of liquid condensate has passed through molecular sieve assembly 320.

Prior to the test sample being processed, adsorbent material 430 has a known initial mass (e.g., 1 kg.). After a comparatively large sample of liquid condensate (e.g., 10 liters) has passed through molecular sieve assembly 320, adsorbent material 430 will have a greater mass (e.g., 1.05 kg) as a result of water being removed from the liquid condensate and adsorbed into adsorbent material 430. The additional 0.05 kg (i.e., 50 grams) of mass reflects the mass of water removed from the dry liquid condensate.

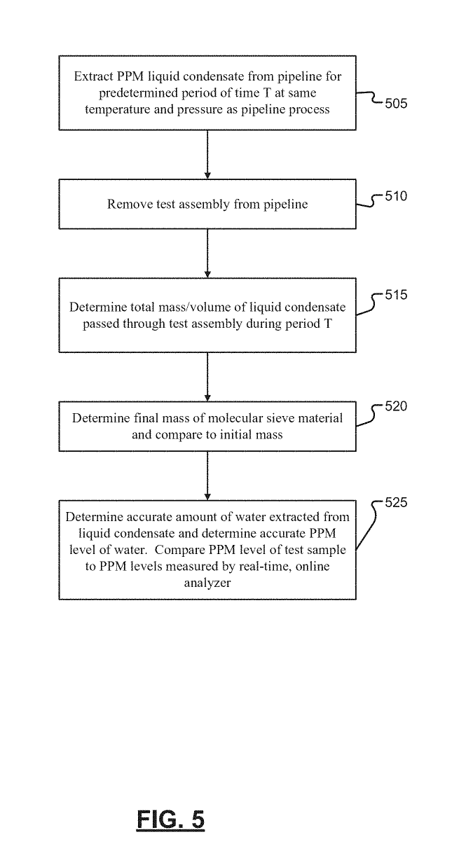

FIG. 5 illustrates a method for validating water measurements in the parts-per-million (PPM) range in a dry liquid condensate according to one embodiment of the disclosure. Initially, molecular sieve assembly 320 extracts PPM liquid condensate from pipeline 205 for a predetermined period of time (T) at the same temperature and pressure as the pipeline process occurring in pipeline 205 (step 505). At the end of time period T, test assembly 140 (or at least molecular sieve assembly 320) is removed from pipeline 205 (step 510).

Flow meter 310 is used to determine the total mass and/or volume of dry liquid condensate that passed through test assembly 140 during the test sample period T (step 515). The molecular sieve beads are removed from molecular sieve assembly 320 and are weighed to determine the final mass of the molecular sieve beads. The final mass (e.g., 1.05 kg.) is compared to the initial mass (e.g., 1 kg.) of the molecular sieve beads (step 520). The comparison determines an accurate amount of water (e.g., 50 grams) that was extracted from the dry liquid condensate. This value may then be used to determine a highly accurate PPM level of water (i.e., concentration of water) in the dry liquid condensate. Finally, the PPM level of the test sample is compared to the PPM levels measured by the real-time, online analyzer (step 525). If the values are the same or relatively close, then the operation and accuracy of real-time, online PPM level moisture measurement analyzer 135 is verified.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus for determining the amount of water in a liquid condensate comprising:
a vessel for containing a stream of liquid condensate, a first section of the vessel comprising an inlet for receiving the stream of liquid condensate and a second section of the vessel comprising an outlet for outputting the stream of liquid condensate, wherein the inlet is configured to be removably coupled to an input feed line and the outlet is configured to be removably coupled to an output feed line;
an adsorbent material disposed in the vessel. for removing water from the liquid condensate; and
a cap configured to be removably coupled to an opening in the vessel to thereby allow the adsorbent to be removed from the vessel.

2. The apparatus as set forth in claim 1, wherein the adsorbent material comprises aluminosilicate crystalline beads.

3. The apparatus as set forth in claim 1, wherein the vessel comprises a cylindrical segment of pipe.

4. The apparatus as set forth in claim 1, further comprising:
i) a spring having a first end in operative contact with an internal surface of the cap; and
ii) a plug, wherein a second end of the spring is in operative contact with the plug such that when the cap is tightened onto the opening in the vessel, the spring forces the plug into contact with the adsorbent material.

5. The apparatus as set forth in claim 1, wherein the adsorbent material adsorbs water from the liquid condensate under temperature and pressure conditions that are substantially similar to the temperature and pressure conditions in a process pipeline from which the liquid condensate is received.

6. A system for determining the amount of water in a liquid condensate comprising:
a flow meter configured to receive a stream of the liquid condensate from a process pipeline and further configured to determine a mass of the liquid condensate passing through the flow meter during a predetermined time period,
a vessel coupled to the flow meter and configured to receive the stream of the liquid condensate from the flow meter, a first section of the vessel comprising an inlet configured to receive the stream of the liquid condensate and a second section of the vessel comprising an outlet configured to output the stream of the liquid condensate, wherein the outlet is configured to be removably coupled to an output feed line;
an adsorbent material disposed in the vessel for removing water from the liquid condensate; and
a cap configured to be removably coupled to an opening in the vessel to thereby allow the adsorbent to be removed from the vessel.

6. The system as set forth in claim 6, wherein the adsorbent material comprises aluminosilicate crystalline beads.

8. The apparatus as set forth in claim 6, wherein the vessel comprises a cylindrical segment of pipe.

9. The apparatus as set forth in claim 6, further comprising:
i) a spring having a first end in operative contact with an internal surface of the cap; and
ii) a plug, wherein a second end of the spring is in operative contact with the plug such that when the cap is tightened onto the opening in the vessel, the spring forces the plug into contact with the adsorbent material.

10. The apparatus as set forth in claim 6, wherein the adsorbent material adsorbs water from the liquid condensate under temperature and pressure conditions that are substantially similar to the temperature and pressure conditions in the process pipeline.

11. A method for determining the amount of water in a liquid condensate comprising:
in a flow meter, receiving a stream of the liquid condensate from a process pipeline and determining a mass of the liquid condensate passing through the flow meter during a sample test period, T;
determining the total mass of the stream of the liquid condensate passing through the flow meter during the sample test period, T;
in a vessel containing an adsorbent material having a known initial mass, receiving the stream of the liquid condensate from the flow meter and removing water from the liquid condensate during the sample test period, T;
determining the final mass of the adsorbent material at the end of the sample test period T;
comparing the known initial mass of the adsorbent material and the final mass of the adsorbent material to determine a mass of adsorbed water; and
using the mass of adsorbed water and the total mass of the stream of the liquid condensate to determine the concentration of water in the liquid condensate.
